(19) United States
(12) Patent Application Publication
(10) Pub. No.: US 2025/0239793 A1
(43) Pub. Date: Jul. 24, 2025

(54) ELECTRIC CONNECTOR

(71) Applicant: HIROSE KOREA CO., LTD., Gyeonggi-do (KR)

(72) Inventor: Guen O LEE, Gyeonggi-do (KR)

(73) Assignee: HIROSE KOREA CO., LTD., Gyeonggi-do (KR)

(21) Appl. No.: 19/020,054

(22) Filed: Jan. 14, 2025

(30) Foreign Application Priority Data
Jan. 22, 2024 (KR) 1020240009744

(51) Int. Cl. H01R 12/71; H01R 13/424

(52) U.S. Cl. CPC H01R 12/716; H01R 13/424

(57) ABSTRACT

Disclosed herein is an electrical connector (10) coupled to a mating connector. The electrical connector (10) includes: a housing (10-5); a signal terminal (10-3); a metal fitting terminal (10-1); and a power terminal (10-2). The metal fitting terminal (10-1) includes a first cover (10-1-C1), a second cover (10-1-C2), and a third cover (10-1-C3). The power terminal (10-2) includes a mounting portion (10-2-M), a bent portion (10-2-C), a connecting portion (10-2-R), and a pair of movable contacts (10-2-T) formed sequentially from an outer side of the electrical connector toward an inner side of the electrical connector in a longitudinal direction of the electrical connector. The bent portion (10-2-C) is located under the second cover (10-1-C2) and overlaps the second cover (10-1-C2) in a height direction of the electrical connector (10).

### TECHNICAL FIELD

The present invention relates to an electrical connector. More particularly, the present invention relates to the structure of a metal fitting terminal and a power terminal of an electrical connector (a plug connector or a receptacle connector (socket connector)).

### BACKGROUND

Generally, interconnection between substrates is established using two connectors that are connected to respective substrates by soldering or the like and are connectable to each other. Here, one of the two connectors is a plug connector and the other is a socket connector. The socket connector is also referred to as a receptacle connector. Such plug and socket connectors may be formed by disposing terminals in a molded part. The plug connector and the socket connector may be fastened to each other to form an electrical connector assembly.

With the trend toward miniaturization of electronic devices, connectors have increasingly become compact in size and height. However, there are certain limitations in making a connector compact in size and height by reducing a pitch between electrical terminals or by scaling down related components.

Miniaturization of connectors makes it more difficult than before to ensure durability thereof. Such connectors are more prone to breakage or deformation under a smaller force due to reduced stiffness thereof.

In addition, two mating connectors can undergo plastic deformation if metal terminals thereof continue to retain a certain shape during or after the process of connecting the connectors to each other. Plastic deformation is the opposite of elastic deformation and refers to irreversible deformation or changes in shape of a material retained after removal of applied load. Even with elasticity, most materials usually undergo deformation when exposed to stress. Therefore, there is a need for a solution to prevent plastic deformation that can occur in connector terminals, which are becoming increasingly reduced in size.

A resin-molded part (housing) of a connector is often manufactured by insert molding. Here, fluidity of a resin used is critical to proper molding of the housing. Therefore, there is a need to improve fluidity of the resin.

In addition, in manufacture of metal terminals, the structures of the terminals and the resin-molded part are limited depending on the manufacturing method thereof (for example, whether deep drawing is used). Therefore, there is a need to consider these points.

Further, during an insert molding process or the like, an injected resin can cover a metal material. Therefore, there is a need to consider this problem.

### SUMMARY

It is one aspect of the present invention to provide an electrical connector which has a power supply structure having sufficient stiffness while having a movable structure with good mobility.

It is another aspect of the present invention to provide an electrical connector which can prevent solder wicking, particularly, solder wicking to a movable structure.

It is a further aspect of the present invention to provide an electrical connector that can be coupled to a mating connector without interference with other members (such as a power terminal of the mating connector) or can prevent reduction in coupling force even if there is some interference.

It should be understood that aspects of the present invention are not limited thereto. The above and other aspects of the present invention will become apparent to those skilled in the art from the detailed description of the following embodiments.

In accordance with an aspect of the present invention, there is provided an electrical connector coupled to a mating connector, including:
a housing including a base, a first wall protruding from an upper surface of the base, a second wall protruding from the upper surface of the base and intersecting the first wall, a third wall protruding from the upper surface of the base, intersecting the second wall, and facing the first wall, and a fourth wall protruding from the upper surface of the base, intersecting the first wall and the third wall, and facing the second wall;
a metal fitting terminal disposed in the housing to be located over the first wall, the second wall, and the third wall;
a plurality of signal terminals disposed on at least the first wall of the housing and arranged in a longitudinal direction of the electrical connector; and
a power terminal disposed on the base of the housing,
wherein the metal fitting terminal includes a first cover covering at least an upper side of the first wall, a second cover covering at least an upper side of the second wall, and a third cover covering at least an upper side of the third wall,
the power terminal includes a mounting portion, a bent portion, a connecting portion, and a pair of movable contacts formed sequentially from an outer side of the electrical connector toward an inner side of the electrical connector in the longitudinal direction of the electrical connector, and
the bent portion is located under the second cover and overlaps the second cover in a height direction of the electrical connector.

Preferably, the first cover, the second cover, and the third cover are connected to each other and continuously connect outer or inner edges of the first wall, the second wall, and the third wall without interruption through a deep drawing process.

Preferably, the second cover has a pair of end mounting portions, and the mounting portion of the power terminal is located between the pair of end mounting portions.

Preferably, the bent portion of the power terminal is embedded in the second wall.

Preferably, the second wall is formed with a groove inside the bent portion.

Preferably, an inner end of the second cover in the longitudinal direction of the electrical connector and an inner end of the bent portion in the longitudinal direction of the electrical connector correspond to each other in the longitudinal direction of the electrical connector.

An electrical connector according to the present invention can prevent solder paste (lead, etc.) from migrating from a power mounting portion (10-2-M) to a movable contact (10-2-T) through a connecting portion (10-2-R) (that is, solder wicking).

In FIG. 3, the circle labeled “Structure A” highlights a region where a bent portion (10-2-C) and a groove (10-5-G1) are present. This structure serves to prevent solder wicking.

Providing a metal fitting (10-1) and a power terminal (10-2) as separate components facilitates formation of the metal fitting (10-1) as a deep-drawn structure and formation of the power terminal (10-2) as a movable contact structure. Given the difficulty of producing a component with a movable structure (the movable contact (10-2-T), etc.) in a single deep drawing operation, this approach offers the advantage of: enhancing the strength of the metal fitting (10-1) by employing a deep-drawn structure as the metal fitting; and ensuring reliable contact of the power terminal (10-2) by employing a movable structure as the power terminal. That is, the present invention ensures that a power supply structure (the power terminal (10-2) and/or a metal fitting (10-1)) has sufficient stiffness while ensuring that a movable structure (the movable contact (10-2-T) of the power terminal (10-2)) has good mobility. Although there is a potential issue where solder wicking at the power terminal (10-2) can restrict movement of the movable contact (10-2-T), this problem can be addressed by Structure A (the bent portion (10-2-C) and the groove (10-5-G1) shown in FIG. 3.

An inner end (10-1-C2E) of the second cover (10-1-C2) (in a longitudinal direction of the connector (10)) and an inner end (10-2-CE) of the bent portion (10-2-C) (in the longitudinal direction of the connector (10)) correspond to each other in the longitudinal direction of the connector (10). In other words, a vertical line drawn downward from the inner end (10-1-C2E) of the second cover (10-1-C2) reaches the inner end (10-2-CE) of the bent portion (10-2-C). This structure allows the inner end (10-1-C2E) of the second cover (10-1-C2), an inner end (10-5-W2E) of the second wall (10-5-W2) (in the longitudinal direction of the connector (10)), and the inner end (10-2-CE) of the bent portion (10-2-C) to be aligned with each other, facilitating positioning of the metal fitting (10-1) relative to the power terminal (10-2), which is a component separate from the metal fitting. In addition, this structure allows the inner end (10-5-W2E) of the second wall (10-5-W2) to be formed in a vertical wall shape, contributing to the shape integrity of the connector (10) (facilitating fitting of the connector (10) into a mating connector (not shown)).

As shown in FIG. 3, the inner end (10-1-C2E) of the second cover (10-1-C2) in the longitudinal direction of the connector 10 and the inner end (10-2-CE) of the bent portion (10-2-C) in the longitudinal direction of the connector (10) correspond to each other in the longitudinal direction of the connector (10), forming a so-called “one-to-one structure”.

If the width of the bent portion (10-2-C) is narrower than shown in FIG. 3 and the inner end (10-2-CE) of the bent portion (10-2-C) is thus located farther to the left, it can be difficult to manufacture the power terminal (10-2) as the bent portion (10-2-C) needs to be folded in a very confined space. This difficulty is particularly pronounced in applications requiring miniaturization of the connector. Additionally, it is difficult to secure a space for formation of the groove (10-5-G1).

Conversely, if the width of the bent portion (10-2-C) is wider than shown in FIG. 3 and the inner end (10-2-CE) of the bent portion (10-2-C) is thus located farther to the right, upon coupling the connector (10) to the mating connector (the receptacle connector (not shown)), the inner end (10-2-CE) of the bent portion (10-2-C) can collide with a power terminal of the mating connector, causing reduction in coupling force, although it is easier to secure a space for folding the bent portion (10-2-C). In addition, to prevent such collision, the power terminal of the mating connector (the receptacle connector (not shown)) is required to have a more complex shape, also causing reduction in coupling force.

In the present invention, to prevent solder wicking, Structure A including the bent portion (10-2-C) and the groove (10-5-G1) formed under the bent portion is provided such that solder paste (for example, lead) can be trapped in the groove (10-5-G1) in the event of solder wicking.

That is, when solder wicking occurs as indicated by arrow D, the solder paste is blocked by the groove (10-5-G1), rather than migrating towards the opposite side (for example, in the direction of the movable contact (10-2-T)) along the power terminal (10-2). Accordingly, even when migration of the solder paste occurs as indicated by arrow D, further migration of the solder paste as indicated by arrow E can be prevented. Thus, Structure A has the effect of preventing solder wicking.

Furthermore, the present invention can prevent solder wicking to the movable contact (10-2-T) (that is, migration of solder paste to the movable contact (10-2-T), which is a movable member not present in other components (the metal fitting (10-1), the signal terminal (10-3), etc.)), thereby providing more effective prevention of solder wicking. In other words, the effect of preventing solder wicking to a movable member (that is, the movable contact (10-2-T)) is much greater than the effect of preventing solder wicking to a non-movable member.

It should be understood that advantageous effects of the present invention are not limited thereto.

The above and other advantageous effects of the present invention will become apparent to those skilled in the art from the detailed description of the following embodiments.

### BRIEF DESCRIPTION OF THE DRAWINGS

The above and other aspects, features, and advantages of the present invention will become apparent from the detailed description of the following embodiments in conjunction with the accompanying drawings:

FIG. 1 is a perspective view of an example of a plug connector (10) among electrical connectors according to the present invention;

FIG. 2a is a top view of the plug connector (10) of FIG. 1;

FIG. 2b is a bottom view of the plug connector 10 of FIG. 1 and FIG. 2a;

FIG. 3 is a perspective view illustrating a cross-section taken along line AA′ of FIG. 2a;

FIG. 4 is a view identical to FIG. 3, specifically focusing on operation of Structure A;

FIG. 5 is a view illustrating a comparative example with respect to FIG. 4 (an example of the present invention);

FIG. 6 is a perspective view illustrating a cross-section taken along line BB′ of FIG. 2a; and

FIG. 7 is a cross-sectional view taken along line CC′ of FIG. 2a.

### DETAILED DESCRIPTION OF EMBODIMENTS

Hereinafter, exemplary embodiments of the present invention will be described with reference to the accompanying drawings. It should be understood that the present invention is not limited to the following embodiments and may be embodied in different ways, and that the embodiments are provided for complete disclosure and thorough understanding of the present invention by those skilled in the art. The scope of the present invention is defined only by the claims. Like components will be denoted by like reference numerals throughout the specification.

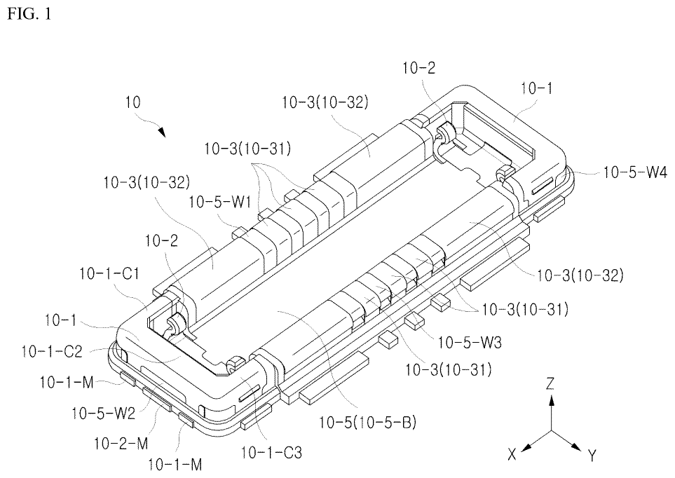

FIG. 1 is a perspective view illustrating an example of a plug connector 10 among electrical connectors according to the present invention.

As used herein, the term “electrical connector” may refer to a plug connector 10, a receptacle connector (not shown) (also referred to as a “socket connector”), or both the plug connector 10 and the receptacle connector (not shown) (or an assembly thereof), depending on the context.

Referring to FIG. 1, the plug connector 10 includes a metal fitting 10-1 (also referred to as a “metal fitting terminal), a power terminal 10-2 (a movable terminal), a signal terminal 10-3, and a housing 10-5 (a molded part).

The metal fitting 10-1 is a metal structure that reinforces the connector 10. The power terminal 10-2 allows input/output of electrical power signals. The signal terminal 10-3 allows input/output of data signals.

Referring to FIG. 1, the metal fitting 10-1 and the power terminal 10-2 are separated so as not to directly contact each other. However, the flow of electric current is not necessarily limited to only the power terminal 10-2. Depending on the structure of a mating connector (a receptacle connector (not shown)), a power terminal of the receptacle connector may adjoin both the metal fitting 10-1 and the power terminal 10-2 of the plug connector 10. Here, electric current can flow not only through the power terminal 10-2 but also through the metal fitting 10-1 upon fitting the plug connector 10 into the receptacle connector (not shown). Of course, this depends on the structure of the receptacle connector (not shown), as described above.

For example, the signal terminal 10-3 may include four pins capable of carrying a current of 0.3 A, or may be a terminal capable of carrying a current of greater than 0.3 A, for example, a current of up to 5 A, to also function as a power terminal. However, the number of pins being four is merely an example. For reference, in the example illustrated in FIG. 1, there are ten signal terminals 10-3 (a combination of two types of signal terminals 10-31, 10-32 with different sizes and/or shapes).

The housing 10-5 has a base 10-5-B. The housing 10-5 has a wall protruding from an upper surface of the base 10-5-B. The metal fitting 10-1, the power terminal 10-2, and the signal terminal 10-3 are formed on the wall.

The wall includes four walls, that is, a first wall 10-5-W1, a second wall 10-5-W2, a third wall 10-5-W3, and a fourth wall 10-5-W4. As shown in FIG. 1, the four walls are connected in a sequence of the first wall 10-5-W1/the second wall 10-5-W2/the third wall 10-5-W3/the fourth wall 10-5-W4 and the fourth wall 10-5-W4 is in turn connected to the first wall 10-5-W1. Referring to FIG. 1, the connector 10 has a generally rectangular shape, wherein the first wall 10-5-W1 and the third wall 10-5-W3 are side walls, and the second wall 10-5-W2 and the fourth wall 10-5-W4 are end walls.

The housing 10-5 (the molded part) of the plug connector 10 is preferably formed of a plastic material, for example, a liquid crystal polymer (LCP). Alternatively, the housing 10-5 may be formed of an insulator, including a resin, an epoxy, and the like, without being limited thereto. The power terminal 10-1 and the signal terminal 10-3 of the plug connector 10 are preferably formed of a metal material, for example, copper or a copper alloy with gold plating (over a nickel underlayer), without being limited thereto.

The signal terminal 10-3 includes two types of signal terminals 10-31, 10-32. The signal terminal 10-3 is disposed on each of the first wall 10-5-W1 and the third wall 10-5-W3.

The metal fitting 10-1 (the metal fitting terminal) includes:
a first cover 10-1-C1 covering an upper side (and an outer side) of the first wall 10-5-W1;
a second cover 10-1-C2 covering an upper side (and an outer side) of the second wall 10-5-W2; and
a third cover 10-1-C3 covering an upper side (and an outer side) of the third wall 10-5-W3.

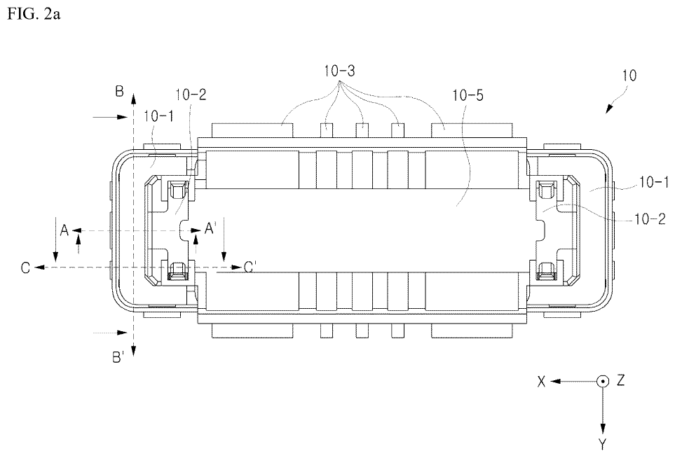

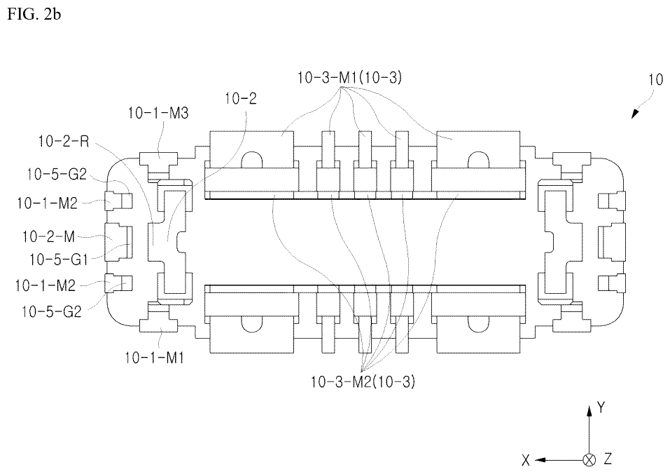

FIG. 2a is a top view of the plug connector 10 of FIG. 1.

As described above with reference to FIG. 1, the plug connector 10 of FIG. 2a includes a metal fitting 10-1 (a metal fitting terminal), a power terminal 10-2, a signal terminal 10-3, and a housing 10-5 (a molded part).

Although not clearly shown in FIG. 1 and FIG. 2a, the metal fitting 10-1 and the power terminal 10-2 are separated so as not to directly contact each other.

However, as described above, the flow of electric current is not necessarily limited to only the power terminal 10-2. That is, when a power terminal of a mating connector (a receptacle connector (not shown)) adjoins both the metal fitting 10-1 and the power terminal 10-2 of the plug connector 10 upon fitting the plug connector 10 into the receptacle connector (not shown), electric current can flow not only through the power terminal 10-2 but also through the metal fitting 10-1. Of course, this depends upon the structure of the receptacle connector (not shown).

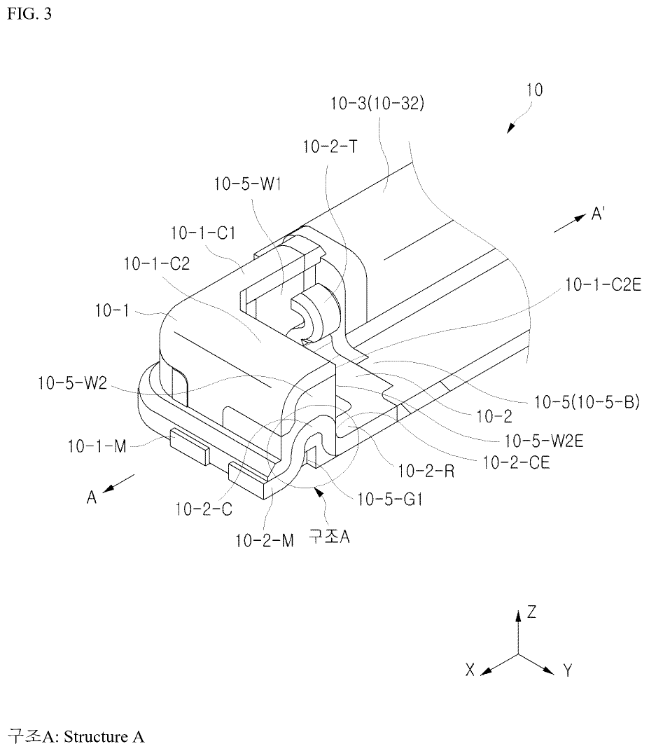

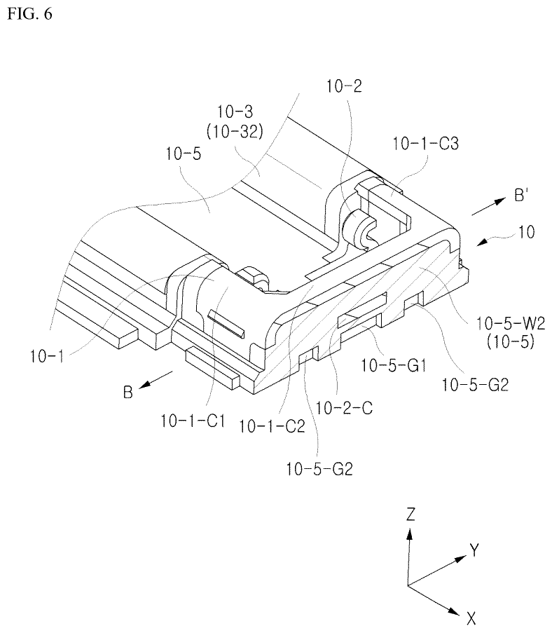

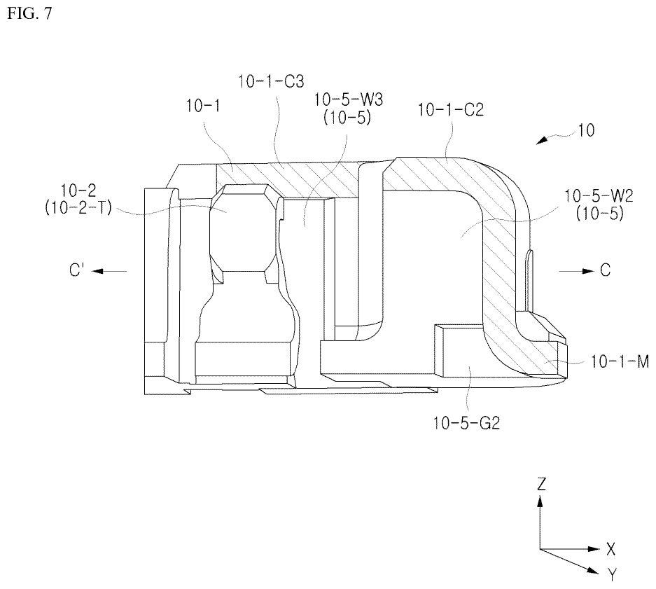

In FIG. 2a, cutting lines AA′, BB′, and CC′ are shown, wherein a cross-section taken along line AA′ is described further below in FIG. 3, a cross-section taken along line BB′ is described further below in FIG. 6, and a cross-section taken along CC′ is described further below in FIG. 7.

FIG. 2b is a bottom view of the plug connector 10 of FIG. 1 and FIG. 2a.

When viewed from below as in FIG. 2b, the plug connector 10 includes a plurality of mounting portions (portions to be mounted on a substrate (not shown) by SMT), in addition to the housing 10-5.

Specifically, the first cover 10-1-C1 of the metal fitting 10-1 has a mounting portion 10-1-M1, the second cover 10-1-C2 has two mounting portions 10-1-M2 (side mounting portions), and the third cover 10-1-C3 has a mounting portion 10-1-M3.

Additionally, each signal terminal 10-3 also has a mounting portion 10-3-M1 at an outer portion thereof in a transverse direction of the connector 10. Furthermore, an inner portion 10-3-M2 of each signal terminal 10-3 in the transverse direction of the connector 10 may also be used as a mounting portion, as needed. That is, in FIG. 2b, a portion denoted by reference numeral 10-3-M1 may be necessarily mounted on the substrate, while a portion denoted by reference numeral 10-3-M2 may be optionally mounted on the substrate, as needed.

Referring to FIG. 2b, the power terminal 10-2 includes a mounting portion 10-2-M. The mounting portion 10-2-M of FIG. 2b is mounted on a substrate (not shown). Although a region near a lower surface of a connecting portion 10-2-R (a bottom of the power terminal 10-2 as shown in FIG. 2b) may also be used as a mounting portion, besides the mounting portion 10-2-M, it is preferable not to use the corresponding region as a mounting portion. As will be described in detail with reference to FIG. 3, one feature of the present invention is that the electrical connector has a bent portion 10-2-C and a groove 10-5-G1 to prevent solder paste (lead, etc.) from migrating from the power mounting portion 10-2-M to a movable contact 10-2-T through the connecting portion 10-2-R (that is, to prevent solder wicking). If the connecting portion 10-2-R (and/or an exposed region near the connecting portion) is used as a mounting portion, this can diminish the effectiveness of the bent portion 10-2-C and the groove 10-5-G1.

FIG. 3 is a perspective view illustrating a cross-section taken along line AA′ of FIG. 2a.

As described in relation to FIG. 1, the metal fitting 10-1 includes a first cover 10-1-C1 covering the upper side of the first wall 10-5-W1, a second cover 10-1-C2 covering the upper side of the second wall 10-5-W2, and a third cover 10-1-C3 covering the upper side of the third wall 10-5-W3.

Although the third cover 10-1-C3 is not shown in FIG. 3 due to cutting, the first cover 10-1-C1 covering the upper side of the first wall 10-5-W1 and the second cover 10-1-C2 covering the upper side of the second wall 10-5-W2 are shown in FIG. 3.

In addition, the cross-section of FIG. 3 shows the structure of the power terminal 10-2.

The power terminal 10-2 has a mounting portion 10-2-M, a bent portion 10-2-C, a connecting portion 10-2-R, and a movable contact 10-2-T from left to right in FIG. 3.

The mounting portion 10-2-M is a portion connected and secured to a substrate (not shown) through soldering or the like upon mounting the connector 10 on the substrate.

The bent portion 10-2-C is a portion formed by bending a portion of the power terminal 10-2 upwards in a convex shape such that a groove 10-5-G1 can be formed thereunder.

The bent portion 10-2-C is connected to a pair of movable contacts 10-2-T through the connecting portion 10-2-R. Although only one movable contact 10-2-T is shown in FIG. 3, it will be understood that there is another movable contact 10-2-T facing the movable contact 10-2-T shown in FIG. 3 (in the transverse direction of the connector 10).

Referring to FIG. 3, the bent portion 10-2-C of the power terminal 10-2 is located under the second cover 10-1-C2 of the metal fitting 10-1 to face (overlap) the second cover 10-1-C2 in a vertical direction (Z direction).

As shown in FIG. 1 to FIG. 3, the first cover 10-1-C1, the second cover 10-1-C2, and the third cover 10-1-C3 are connected to each other. These interconnected members (the first cover 10-1-C1, the second cover 10-1-C2, and the third cover 10-1-C3) continuously connect the outer or inner edges of the first wall portion 10-5-W1, the second wall portion 10-5-W2, and the third wall portion 10-5-W3 without interruption through a deep drawing process.

As shown in FIG. 1 and FIG. 3, the second cover 10-1-C2 has a pair of end mounting portions 10-1-M2, and the power mounting portion 10-2-M of the power terminal 10-2 is located between the pair of end mounting portions 10-1-M2.

Referring to FIG. 3, the bent portion 10-2-C is embedded in the second wall 10-5-W2, and the second wall 10-5-W2 is formed with the groove 10-5-G1 inside the bent portion 10-2-C.

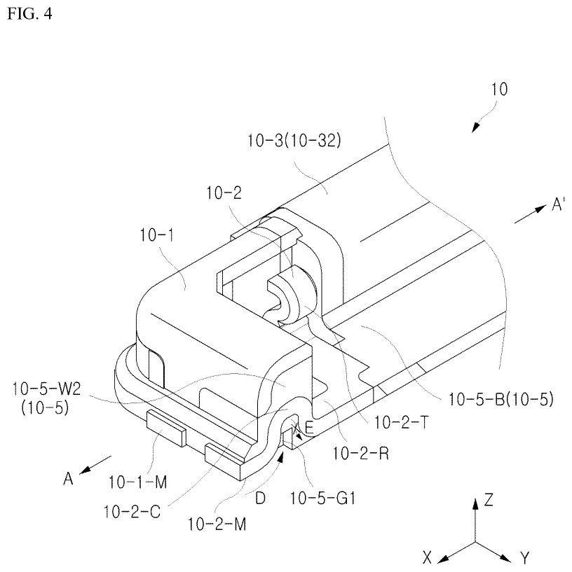

In FIG. 3, the circle labeled “Structure A” highlights a region where the bent portion 10-2-C and the groove 10-5-G1 are present. This structure serves to prevent solder wicking. This feature will be described further below with reference to FIG. 4.

As described above, the metal fitting 10-1 and the power terminal 10-2 are provided as separate components and are spaced apart from each other. Of course, there may be cases in which the power terminal of the mating connector contacts both the metal fitting 10-1 and the power terminal 10-2, causing the metal fitting 10-1 and the power terminal 10-2 to be electrically connected to each other (here, electric current can also flow through the metal fitting 10-1). However, considering the plug connector 10 alone, the metal fitting 10-1 and the power terminal 10-2 are separate components spaced apart from each other.

Providing the metal fitting 10-1 and the power terminal 10-2 as separate components facilitates formation of the metal fitting 10-1 as a deep-drawn structure and formation of the power terminal 10-2 as a movable contact structure. Given the difficulty of producing a component with a movable structure (such as the movable contact 10-2-T) in a single deep drawing operation, this approach offers the advantage of: enhancing the strength of the metal fitting 10-1 by employing a deep-drawn structure as the metal fitting; and ensuring reliable contact of the power terminal 10-2 by employing a movable structure as the power terminal. Although there is a potential issue where solder wicking at the power terminal 10-2 can restrict movement of the movable contact 10-2-T, this problem can be addressed by Structure A (the bent portion 10-2-C and the groove 10-5-G1) depicted in FIG. 3. This will be described in detail with reference to FIG. 4.

In addition, an inner end 10-1-C2E of the second cover 10-1-C2 (in the longitudinal direction of the connector 10) and an inner end 10-2-CE of the bent portion 10-2-C (in the longitudinal direction of the connector 10) correspond to each other in the longitudinal direction of the connector 10. That is, in plan view of the connector 10, the inner end 10-1-C2E of the second cover 10-1-C2 and the inner end 10-2-CE of the bent portion 10-2-C overlap each other at the same location in the longitudinal direction of the connector 10.

In other words, a vertical line drawn downward from the inner end 10-1-C2E of the second cover 10-1-C2 reaches the inner end 10-2-CE of the bent portion 10-2-C. This structure allows the inner end 10-1-C2E of the second cover 10-1-C2, the inner end 10-5-W2E of the second wall 10-5-W2 (in the longitudinal direction of the connector 10), and the inner end 10-2-CE of the bent portion 10-2-C to be aligned with each other, facilitating positioning of the metal fitting 10-1 relative to the power terminal 10-2, which is a component separate from the metal fitting. In addition, this structure allows the inner end 10-5-W2E of the second wall 10-5-W2 to be formed in a vertical wall shape, contributing to the shape integrity of the connector 10 (facilitating fitting of the connector 10 into the mating connector (not shown)).

As shown in FIG. 3, the inner end 10-1-C2E of the second cover 10-1-C2 in the longitudinal direction of the connector 10 and the inner end 10-2-CE of the bent portion 10-2-C in the longitudinal direction of the connector 10 correspond to each other in the longitudinal direction of the connector 10, forming a so-called “one-to-one structure”.

If the width of the bent portion 10-2-C is narrower than shown in FIG. 3 and the inner end 10-2-CE of the bent portion 10-2-C is thus located farther to the left, it can be difficult to manufacture the power terminal 10-2 as the bent portion 10-2-C needs to be folded in a very confined space. This difficulty is particularly pronounced in applications requiring miniaturization of the connector. Additionally, it is difficult to secure a space for formation of the groove 10-5-G1.

Conversely, if the width of the bent portion 10-2-C is wider than shown in FIG. 3 and the inner end 10-2-CE of the bent portion 10-2-C is thus located farther to the right, upon coupling the connector 10 to the mating connector (the receptacle connector (not shown)), the inner end 10-2-CE of the bent portion 10-2-C can collide with the power terminal of the mating connector, causing reduction in coupling force, although it is easier to secure a space for folding the bent portion 10-2-C. In addition, to prevent such collision, the power terminal of the mating connector (the receptacle connector (not shown)) is required to have a more complex shape, also causing reduction in coupling force.

Through employment of the aforementioned one-to-one structure, the electrical connector according to the present invention can eliminate interference with other members (a power terminal of a mating connector (a receptacle connector (not shown), etc.), or can ensure that coupling force remains unaffected even when there is some interference with other members.

FIG. 4 is a view identical to FIG. 3, specifically focusing on operation of Structure A.

The region highlighted by the circle labeled “Structure A” in FIG. 3 will be described in detail with reference to FIG. 4.

In this region, there is a bent portion 10-2-C and a groove 10-5-G1. Although it is desirable that the groove 10-5-G1 adjoin the bent portion 10-2-C as shown in FIG. 4, the present invention is not limited thereto and the groove 10-5-G1 may be located under the bent portion 10-2-C without adjoining the bent portion 10-2-C.

Referring to FIG. 4, a mold (not shown) with the metal fitting 10-1, the power terminal 10-2, and the signal terminal 10-3 secured thereto is filled with a molding material to form the housing 10-5.

Thereafter, the mounting portion 10-2-M of the power terminal 10-2, the mounting portion 10-1-M2 of the metal fitting 10-1, and the mounting portion (not shown in FIG. 4) of the signal terminal 10-3 are surface-mounted on a substrate.

Surface mount technology (SMT) refers to a method in which solder paste (lead, etc.) is printed onto a PCB (not shown), followed by mounting a chip component (for example, the connector 10 according to the present invention) thereon through a reflow process, thereby joining the chip component to the PCB (not shown).

Among the mounting portion 10-2-M of the power terminal 10-2, the mounting portion 10-1-M2 of the metal fitting 10-1, and the mounting portion (not shown in FIG. 4) of the signal terminal 10-3, the following description will focus on surface-mounting of the mounting portion 10-2-M of the power terminal 10-2. Due to undesirable process conditions such as excessive solder paste volume, extended reflow time, or high temperature, solder paste near the mounting portion 10-2-M can migrate to other regions connected to the mounting portion 10-2-M (for example, the movable contact 10-2-T). This phenomenon is called “solder wicking”.

In the present invention, to prevent solder wicking, Structure A including the bent portion 10-2-C and the groove 10-5-G1 formed under the bent portion is provided such that solder paste (for example, lead) can be trapped in the groove 10-5-G1 in the event of solder wicking.

That is, when solder wicking occurs as indicated by arrow D, the solder paste is blocked by the groove 10-5-G1, rather than migrating towards the opposite side (for example, in the direction of the movable contact 10-2-T) along the power terminal 10-2. Accordingly, even when migration of the solder paste occurs as indicated by arrow D, further migration of the solder paste as indicated by arrow E can be prevented.

Thus, Structure A has the effect of preventing solder wicking.

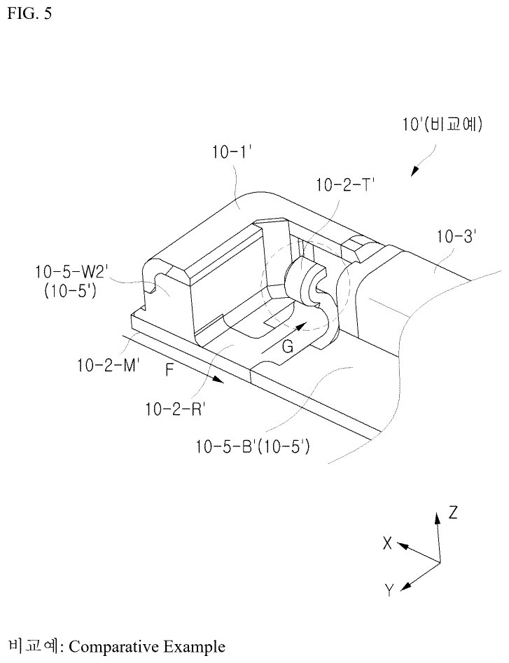

FIG. 5 is a view illustrating a comparative example with respect to FIG. 4 (an example according to the present invention).

Referring to FIG. 5, a mounting portion 10-2-M′ is directly connected to a connecting portion 10-2-R′ without Structure A of FIG. 3 and FIG. 4 (that is, without any intervening bent portion or groove) and the connecting portion 10-2-R′ is in turn connected to a movable contact 10-2-T′.

In the comparative example of FIG. 5, upon surface-mounting the mounting portion 10-2-M′ on a substrate (such as a PCB (not shown)) using a solder paste (lead, etc.), the solder paste near the mounting portion 10-2-M′ can migrate to the connecting portion 10-2-R′ along arrow F (solder wicking) due to undesirable process conditions, such as excessive solder paste volume, extended reflow time, or high temperature, and then can migrate to the movable contact 10-2-T′ indicated by the circle along arrow G (solder wicking).

If solder wicking occurs and solder paste (lead, etc.) migrates to the movable contact 10-2-T′ as in the comparative example, the movable contact 10-2-T′ can loss some of the elasticity (or mobility) thereof depending on the amount of solder paste added thereto due to solder wicking, potentially preventing the movable contact 10-2-T′ from moving as designed. If the stiffness of the movable contact 10-2-T′ exceeds a design limit, it can become difficult to fit (mate) the plug connector into (with) the receptacle connector or to disconnect the plug connector from the receptacle connector. In particular, for very small connectors 10 in which the power terminal 10-2 is also small in size and thickness, the impact of solder wicking on mobility of the movable contact 10-2-T is not negligible.

Accordingly, by employing Structure A of FIG. 4, rather than the structure as in the comparative example of FIG. 5, the present invention can achieve at least the aforementioned technical advantages.

FIG. 6 is a perspective view illustrating a cross-section taken along line BB′ of FIG. 2a.

The cross-section shown in FIG. 6 is taken along the transverse direction of the connector 10.

The majority of the cross-section is occupied by the second wall 10-5-W2, which is part of the housing 10-5, an upper portion of the cross-section shows the first cover 10-1-C1, the second cover 10-1-C2, and the third cover 10-1-C3 connected in sequence, a middle portion of the cross-section shows an apex of the bent portion 10-2-C, and a lower portion of the cross-section shows one central groove 10-5-G1 and two lateral grooves 10-5-G2.

Although the lateral grooves 10-5-G2 may also serve to prevent solder wicking, the central groove 10-5-G1 plays a more critical role. Assuming that the power mounting portion 10-2-M and the connecting portion 10-2-R are connected to each other in a straight line (without the bent portion 10-2-C) while exposing a lower surface of the power terminal (that is, assuming that the bottom view of FIG. 2b is modified like the comparative example of FIG. 5), solder paste can very easily migrate to the movable contact 10-2-T along the straight lower surface of the power terminal.

On the other hand, although the lateral grooves 10-5-G2 near the end mounting portions 10-1-M2 also serve to prevent solder wicking, the end mounting portions are inevitably partially embedded in the second wall 10-5-W2 due to the structure thereof. Accordingly, the potential for solder wicking at the end mounting portions is inherently low, compared to a power terminal having a structure in which the power mounting portion and the connecting portion are connected to each other in a straight line (without the bent portion 10-2-C) while exposing a lower surface of the power terminal as in FIG. 5. Furthermore, since the metal fitting 10-1 including the end mounting portions 10-1-M2 does not have a movable portion, the degree of performance degradation thereof is low even when solder wicking occurs.

In the case of the power terminal 10-2, it would be more natural for the power terminal 10-2 to have a straight, exposed lower surface (without the bent portion 10-2-C) as in the comparative example of FIG. 5. However, instead of adopting the structure of FIG. 5, the present invention adopts a structure in which the bent portion 10-2-C is interposed between the mounting portion 10-2-M and the connecting portion 10-2-R despite increased complexity of the manufacturing process such that the power terminal 10-2, which originally does not need to be embedded in the second wall 10-5-W2, can be partially embedded in the second wall 10-5-W2 while the groove 10-5-G1 can be formed to trap solder paste therein, thereby preventing solder wicking. Furthermore, the present invention can prevent solder wicking to the movable contact 10-2-T (that is, migration of solder paste to the movable contact 10-2-T, which is a movable member not present in other components (the metal fitting 10-1, the signal terminal 10-3, etc.)), thereby providing more effective prevention of solder wicking. In other words, the effect of preventing solder wicking to a movable member (that is, the movable contact 10-2-T) is much greater than the effect of preventing solder wicking to a non-movable member.

FIG. 7 is a cross-sectional view taken along line CC′ of FIG. 2a.

The cross-section of FIG. 7 lies on a different plane than the cross-section of FIG. 3 and is parallel to the cross-section of FIG. 3.

That is, the cross-section of FIG. 3 is an XZ plane passing through the central groove 10-5-G1, while the cross-section of FIG. 7 is an XZ plane passing through the lateral grooves 10-5-G2.

As shown in FIG. 7, the lateral grooves 10-5-G2 near the right and left end mounting portions 10-1-M2 also serve to prevent solder wicking. However, since end mounting portions are inevitably partially embedded in the second wall 10-5-W2 due to the structure thereof, as described above, the potential for solder wicking at the end mounting portions is inherently low, compared to a power terminal having as structure in which the power mounting portion and the connecting portion are connected to each other in a straight line (without the bent portion 10-2-C) while exposing a lower surface of the power terminal as in FIG. 5. Furthermore, since the metal fitting 10-1 including the end mounting portions 10-1-M2 does not have a movable portion, the degree of performance degradation thereof is low even when solder wicking occurs.

That is, as described above, although it is rather easy to make the power terminal 10-2 have a straight, exposed lower surface without a bent portion as in the comparative example of FIG. 5, the present invention deliberately introduces the bent portion 10-2-C (and the groove 10-5-G1) as in FIG. 3 and FIG. 4 to achieve a unique effect.

On the other hand, the metal fitting 10-1 including the side mounting portions 10-1-M2 near the grooves 10-5-G2 is inherently curved as shown in FIG. 3 and FIG. 7 and is thus blocked by the second wall 10-5-W2, and the like. That is, although the groove 10-5-G1 near the power mounting portion 10-2-M may appear to be similar in shape and function to the grooves 10-5-G2 near the side mounting portions 10-1-M2, the groove 10-5-G1 and the grooves 10-5-G2 have different technical features. While the side mounting portions 10-1-M2 near the grooves 10-5-G2 inherently have such a curved shape (connected to the second cover 10-1-C2), the power mounting portion 10-2-M near the groove 10-5-G1 is modified in shape to have an embedded portion and to form the groove 10-1-G1, although the power mounting portion would naturally have a straight or flat shape without the bent portion 10-2-C (refer to the comparative example of FIG. 5).

Furthermore, as described above, since the modified shape of the power mounting portion 10-2-M prevents solder wicking to the movable contact 10-2-T (that is, migration of solder paste to the movable contact 10-2-T, which is a movable member not present in other components (the metal fitting 10-1, the signal terminal 10-3, etc.)), the present invention can ensure more effective prevention of solder wicking. In other words, although the grooves 10-5-G2 and the side mounting portions 10-1-M2 are highly effective at preventing solder wicking to a non-movable member, the combination of the groove 10-5-G1, the power mounting portion 10-2-M, and the bent portion 10-2-C has a distinct and separate technical significance in preventing solder wicking to a movable member, particularly the movable contact 10-2-T.

It should be understood that the foregoing is merely illustrative of the features and advantages of the present invention and is not intended to limit the present invention thereto.

In addition, the foregoing description of the plug connector 10 may also be applied to a receptacle connector (not shown) (a socket connector) to the extent that it is not contrary to the nature of the receptacle connector.

Although some embodiments have been described herein in conjunction with the accompanying drawings, it should be understood that the present invention is not limited to the embodiments and may be embodied in different ways, and that various modifications, changes, alterations, and equivalent embodiments can be made by those skilled in the art without departing from the spirit and scope of the invention. Therefore, it should be understood that the foregoing embodiments are provided for illustration only and are not to be in any way construed as limiting the present invention.

### LIST OF REFERENCE NUMERALS

10: (Plug) connector
10-1: Metal fitting terminal (metal fitting)
10-1-C1: First cover
10-1-M1: Mounting portion (of first cover) on substrate (not shown)
10-1-C2: Second cover
10-1-C2E: Inner end (of second cover (10-1-C2)) in longitudinal direction of connector (10)
10-1-M2: Second mounting portion (side mounting portion) (of second cover) on substrate (not shown)
10-1-C3: Third cover
10-1-M3: Third mounting portion (of third cover) on substrate (not shown)
10-2: Power terminal (movable terminal)
10-2-M: Power mounting portion
10-2-C: Bent portion
10-2-CE: Inner end (of bent portion (10-2-C)) in longitudinal direction of connector (10)
10-2-R: Connecting portion
10-2-T: Movable contact
10-3: Signal terminal
10-31: Signal terminal (example of signal terminal (10-3))
10-32: Signal terminal (example of signal terminal (10-3))
10-3-M1: Mounting portion (of signal terminal (10-3)) on substrate (not shown)
10-5: Housing (molded part)
10-5-B: Base
10-5-W1: First wall
10-5-W2: Second wall
10-5-W2E: Inner end (of second wall (10-5-W2)) in longitudinal direction of connector (10)
10-5-W3: Third wall
10-5-W4: Fourth wall
10-2-M′: Mounting portion of power terminal according to comparative example
10-2-R′: Connecting portion of power terminal according to comparative example
10-2-T′: Movable contact of power terminal according to comparative example

1. An electrical connector coupled to a mating connector, comprising:
a housing comprising a base, a first wall protruding from an upper surface of the base, a second wall protruding from the upper surface of the base and intersecting the first wall, a third wall protruding from the upper surface of the base, intersecting the second wall, and facing the first wall, and a fourth wall protruding from the upper surface of the base, intersecting the first wall and the third wall, and facing the second wall;
a metal fitting terminal disposed in the housing to be located over the first wall, the second wall, and the third wall;
a plurality of signal terminals disposed on at least the first wall of the housing and arranged in a longitudinal direction of the electrical connector; and
a power terminal disposed on the base of the housing,
wherein the metal fitting terminal comprises a first cover covering at least an upper side of the first wall, a second cover covering at least an upper side of the second wall, and a third cover covering at least an upper side of the third wall,
the power terminal comprises a mounting portion, a bent portion, a connecting portion, and a pair of movable contacts formed sequentially from an outer side of the electrical connector toward an inner side of the electrical connector in the longitudinal direction of the electrical connector, and
the bent portion is located under the second cover and overlaps the second cover in a height direction of the electrical connector.

2. The electrical connector according to claim 1, wherein the first cover, the second cover, and the third cover are connected to each other and continuously connect outer or inner edges of the first wall, the second wall, and the third wall without interruption through a deep drawing process.

3. The electrical connector according to claim 1, wherein the second cover has a pair of end mounting portions, and the mounting portion of the power terminal is located between the pair of end mounting portions.

4. The electrical connector according to claim 1, wherein the bent portion of the power terminal is embedded in the second wall.

5. The electrical connector according to claim 1, wherein the second wall is formed with a groove inside the bent portion.

6. The electrical connector according to claim 1, wherein an inner end of the second cover in the longitudinal direction of the electrical connector and an inner end of the bent portion in the longitudinal direction of the electrical connector correspond to each other in the longitudinal direction of the electrical connector.
